(19) United States
(12) Patent Application Publication
(10) Pub. No.: US 2001/0028170 A1
(43) Pub. Date: Oct. 11, 2001

(54) Tube nut and threaded connection between a brake hose and a brake line

(76) Inventors: Andreas Sausner, Frankfurt (DE); Willi Hartmann, Riedstadt (DE); Peter Low, Gravenwiesbach (DE)

Correspondence Address: Andrew R. Basile, Young & Basile, P.C., 3001 West Big Beaver Road, Suite 624, Troy, MI, 48084, US

(21) Appl. No.: 09/826,026

(22) Filed: Apr. 4, 2001

(30) Foreign Application Priority Data
Apr. 6, 2000 (DE) 100 17 254.7

(51) Int. Cl. F16L 33/00

(52) U.S. Cl. 285/256

(57) ABSTRACT

A tube nut and a threaded connection between a brake hose and a brake line, as well as a tool for tightening and loosening the tube nut according to the invention are proposed. The tube nut according to the invention permits high torque levels to be transmitted between the tube nut and the tool. In addition, the space required for assembly is reduced.

### BACKGROUND

The invention relates to a tube nut with a center hole with an external thread and with means to tighten the tube nut, in addition to a threaded connection between a brake hose and a brake line with an internally threaded fitting and with a tube nut, where the internally threaded fitting is connected to a brake hose and where the brake line passes through a center hole in the tube nut and has a flare at the end facing the internally threaded fitting. The invention also relates to a tool for tightening and loosening the tube nut according to the invention.

Threaded connections between a brake hose and a brake line are standardized in DIN 74 234. This connection consists basically of an internally threaded fitting which is pressed together with a brake hose, and a brake line whose end is flared. Under DIN 74 234, flares having Form E or Form F can be used. This flare is pressed to seat tightly in the internally threaded fitting with the aid of a tube nut with an external hex head and thereby seals the line and the hose against the environment.

The disadvantage with this type of threaded connection is that the protruding hex head of the tube nut requires a lot of space and in addition the tightening tools (wrench or the like) require a great deal of space. Since threaded connections of this kind between the brake line and the brake hose, at least during service or repair of brake systems in motor vehicles, are loosened under non-ergonomic conditions, for example, over head and in cramped spaces, this aspect is critical for the assembly and maintenance of the brake system. In addition, the torque transferable between the tool and the bolt head is limited by the shape of the bolt head.

### SUMMARY

The object of the invention is then to provide a tube nut for a threaded connection between a brake hose and a brake line, or respectively, to provide a threaded connection between a brake hose and a brake line, in which cases the space requirement is reduced, assembly is made considerably easier, or even made possible, even in restricted spaces, and in addition high torque can be transmitted between tool and tube nut.

This object is fulfilled according to the invention by means of a tube nut with a center hole, with an external thread and with means to tighten the tube nut, where the means to tighten the tube nut is a prismatic recess running coaxially to the longitudinal axis of the center hole, where the recess has a polygonal cross section.

This tube nut has the advantage that the diameter of the bolt head is smaller than the core diameter of the external thread and still a high torque can be transmitted. As a result, the maximum diameter of the tube nut can be reduced. This, in conjunction with the similarly reduced dimensions of the tool required to tighten and loosen the tube nut, results in a clear overall reduction of the space required for installation. In addition, no force in an axial direction, which pushes the tool out of the prismatic recess, is created between the prismatic recess and the tool for tightening and loosening the tube nut. Finally, the tube nut according to the invention results in reduction of weight.

In a variation of the invention, it is provided that the cross section of the recess is an internal TORX shape, so that the advantages of these bolts from the CAMCAR Co., Rockford, Ill., USA, can be utilized for the tube nut according to the invention. Such advantages are primarily these: reduction of radial forces on the bolt head, a further increase in transmittable torque, and extended service life of the tool for tightening and loosening the tube nut.

As a supplement to the invention, the cross section of the recess is an internal hex socket, so that production of the recess is simplified.

As a further supplement to the invention, it is provided that the corners of the polygonal cross section are rounded off, so that the stress peaks in the corners of the polygonal cross section are reduced. In another embodiment of the invention, the external thread extends over the entire length of the tube nut, so that the bolt head can be integrated into the body of the tube nut and installation space can be saved. In one embodiment of the invention, the tube nut serves to provide a threaded connection between a conduit, specifically a motor vehicle brake line, and an internally threaded fitting.

The object under the invention is also fulfilled by means of a threaded connection between a brake hose and a brake line with an internally threaded fitting and with a tube nut, where the internally threaded fitting is connected to a brake hose and where the brake line passes through a center hole of the tube nut and, at the end facing the internally threaded fitting, has a flare, where the tube nut can be tightened together with the internally threaded fitting.

With this threaded connection, the advantages according to the invention of the tube nuts can be used to the full extent. In addition, the brake line and the brake hose can be pre-assembled at the manufacturer of these components with the help of the threaded connection according to the invention, and this subassembly, consisting of brake hose and brake line can be shipped complete to the customer, usually a motor vehicle manufacturer. When this subassembly is installed, only the tube nut needs to be tightened.

Fulfilling the object of the invention is also made possible by means of a tool for tightening a tube nut with a shaft, which at one end has a shape that works in conjunction with the prismatic recess, and where the shaft has a center hole and the tool can be separated along a plane which runs through the longitudinal axis of the shaft.

Using this tool, the tube nuts according to the invention can be tightened at high torque without the risk of damaging the bolt head, even if they have been pushed over a brake line.

As a supplement to the invention, at least one lever bears on the shaft, and the longitudinal axis of the shaft and the longitudinal axis of the lever enclose an angle, specifically of 90°, so that with little manual force a high torque can be transmitted to the tube nut according to the invention.

Additional advantages of the invention can be found in the drawing, the ensuing description and the claims for the patent.

### BRIEF DESCRIPTION OF THE DRAWINGS

One practical example the invention is shown in the drawing and described in greater detail below in which:

FIG. 1 is a threaded connection according to the invention in cross section;

FIG. 2 is a side view of a threaded connection according to the invention;

FIG. 3 is a threaded connection from the prior art with an external hexagon head on the tube nut;

FIG. 4a is an exploded view of a tool for tightening the tube nut according to the invention; and

FIG. 4b is a bottom view of the tool in FIG. 4a.

### DETAILED DESCRIPTION

FIG. 1 shows an internally threaded fitting 1 according to the prior art, which is pressed together with a brake hose 3. A brake line 7 with a flare 9 is pressed into a seat 5. The required force is generated by means of a tube nut 11 with a center hole 12. The tube nut 11 has an external thread, which works in conjunction with a matching internal thread in the internally threaded fitting 1. The required tightening torque is generated by means of a polygonal recess 15.

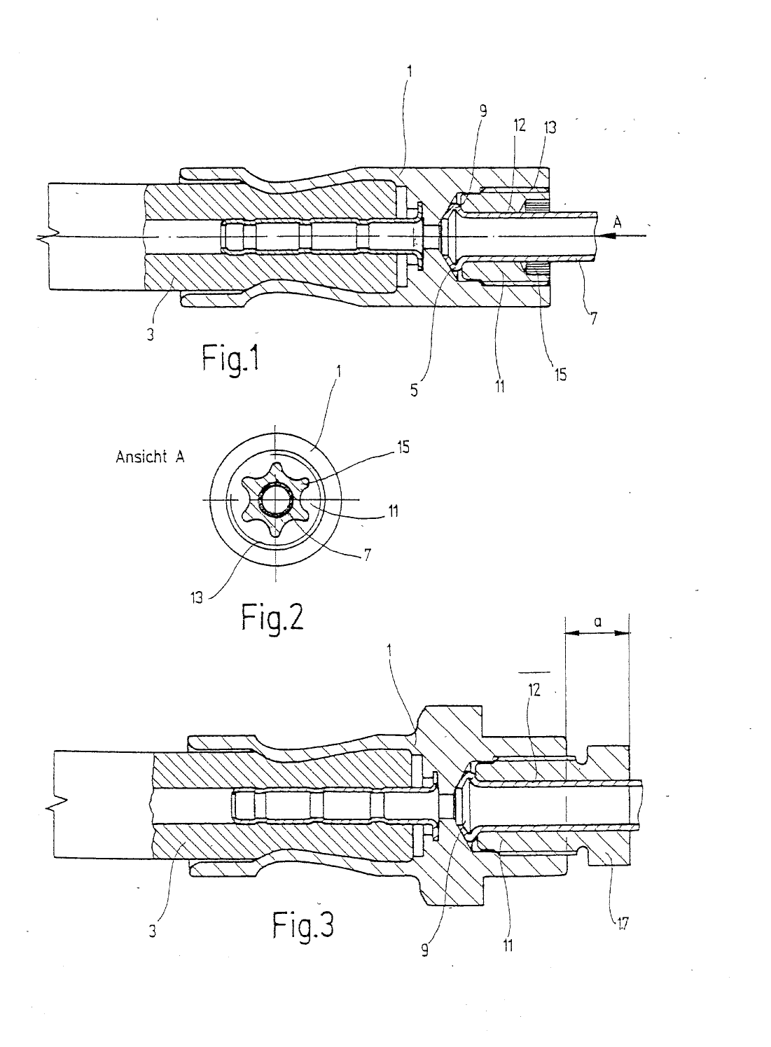

FIG. 2 shows a side view of the threaded connection. In the example of the version shown, the recess 15 has the cross section of a TORX shape. This TORX shape has the advantage that very high torque can be transferred between the tool and the bolt head in an extremely small space. In addition, during tightening or loosening, the tool, which is not shown, is not pushed out of the prismatic recess 15, and no radial forces are created between the recess 15 and the tool.

From FIG. 2 it can be seen that the dimensions of the TORX shape are smaller than the core diameter of the external thread 13. For this reason, the recess 15 can be integrated completely into the body of the tube nut 11, so that the installation length of the tube nut 11 according to the invention is reduced. In addition, the result of integrating the recess 15 into the body of the tube nut 11 in the fully inserted position is that any potential widening of the recess 15 when the tube nut 11 is tightened is prevented. This is particularly evident from FIG. 1, in which the tube nut 11 is clearly not extending beyond the internally threaded fitting 1.

For comparison, FIG. 3 shows a threaded connection with a tube nut know to the prior art. The hexagon head 17 of the tube nut 11 is protruding beyond the internally threaded fitting 1, so that the installation length of the tube nut known to the prior art is longer by about the amount a than the internally threaded fitting according to the invention.

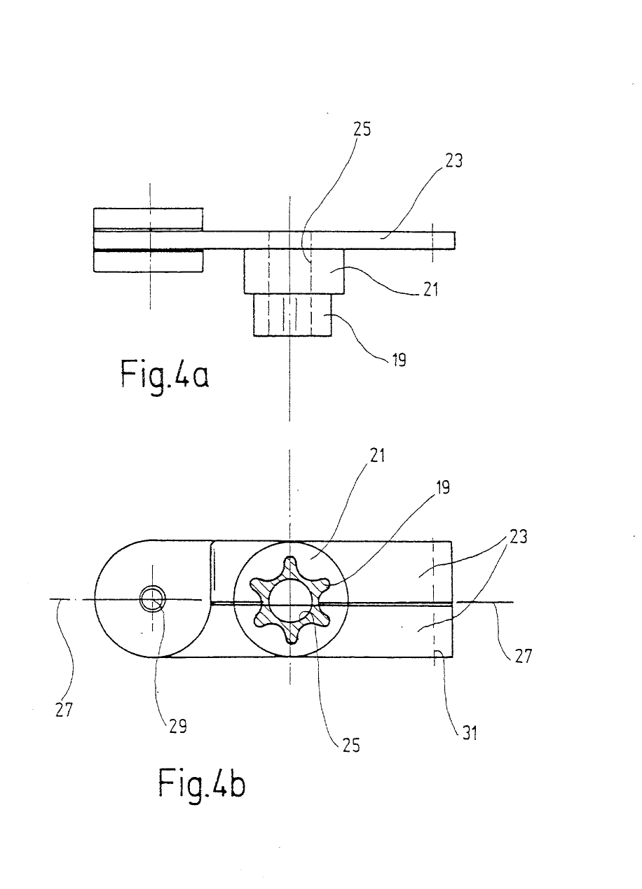

FIGS. 4a and 4b show a separable tool for tightening the tube nut 11 according to the invention. FIG. 4a shows a side view of the tool, with a shaped section 19, a shaft 21 and a lever 23. The shaped section 19 is formed in such a way that it can be inserted into the recess 15 of the tube nut 11 according to the invention and torque can be transmitted between the tool and the tube nut 11 according to the invention. The tool also has a center hole 12, which can accept the brake line, which is not shown.

FIG. 4b shows a view of the tool according to the invention from below. It can be seen that the shaped piece 19, the shaft 21 and the lever 23 can be separated along a dividing plane 27 by rotating them about a pivot point 29. In the open position, the tool can be pushed over the brake line and then closed again. So that the tool does not come open while tightening, the two halves of the lever 23 are locked together by a threaded connector pictorially represented by reference number 31. In this position, the tube nut 11 according to the invention can be tightened against the internally threaded fitting.

All the features presented in the description, the ensuing claims and the drawing can be fundamental to the invention both individually and combined in whole or in part.

What is claimed is:

1. Tube nut with a center hole (12), with an external thread (13) and with means to tighten the tube nut (11), characterized in that the means to tighten the tube nut (11) is a prismatic recess (15) running coaxially to the longitudinal axis of the center hole (12), and that the recess (15) has a polygonal cross section.

2. Tube nut in accordance with claim 1, wherein the cross section of the recess (15) is an internal TORX shape.

3. Tube nut in accordance with claim 1, wherein the cross section of the recess (15) is a hex head socket.

4. Tube nut in accordance with one of the preceding claims, wherein the corners of the polygonal cross section are rounded off.

5. Tube nut in accordance with one of the preceding claims, wherein the external thread (13) extends over the entire length of the tube nut (11).

6. Tube nut in accordance with one of the preceding claims, wherein it serves to fasten together a conduit, specifically a motor vehicle brake line (7) with an internally threaded fitting (1).

7. Threaded connection between a brake hose (3) and a brake line (7) with an internally threaded fitting (1) and with a tube nut (11), wherein the internally threaded fitting (1) is connected to a brake hose (3) and wherein the brake line (7) passes through a center hole (12) in the tube nut (11) and has a flare at the end facing the internally threaded fitting, and wherein the tube nut (11) can be tightened together with the internally threaded fitting (1), wherein the tube nut (11) is a tube nut (11) in accordance with one of the claims 1 to 6.

8. Tool for tightening a tube nut in accordance with one of the preceding claims with a shaft (21), which at one end has a shape which acts together with the prismatic recess (15) in accordance with one of the claims 1 to 5, wherein the shaft has a center hole (25), the tool can be separated along one plane (27), and the longitudinal axis of the shaft (21) lies in the plane of the division (27).

9. Tool in accordance with claim 7, wherein at least one lever (23) bears on the shaft (21), and the longitudinal axis of the shaft (21) and the longitudinal axis of the lever (23) include an angle, specifically of 90°.
